(19) United States
(12) Patent Application Publication
(10) Pub. No.: US 2019/0078500 A1
(43) Pub. Date: Mar. 14, 2019

(54) GASOLINE DIRECT INJECTION ENGINE

(71) Applicants: Hyundai Motor Company, Seoul (KR); Kia Motors Corporation, Seoul (KR)

(72) Inventors: In Gee Suh, Yongin (KR); Woo Tae Kim, Anyang (KR); Min Gi Choi, Hwaseong (KR)

(21) Appl. No.: 15/825,446

(22) Filed: Nov. 29, 2017

(30) Foreign Application Priority Data
Sep. 11, 2017 (KR) 10-2017-0115972

(51) Int. Cl. F02B 23/10

(52) U.S. Cl. CPC F02B 23/104; F02B 2075/125; F02B 2023/106

(57) ABSTRACT

A gasoline direct injection engine is provided in which fuel is directly injected by an injector disposed at a side of an exhaust port. The gasoline direct injection engine includes an injector that directly injects fuel into a combustion chamber, a spark plug, an intake port, an exhaust port, and a piston head The intake port and the exhaust port are disposed to face each other based on an installation location of the spark plug, and the injector is disposed at a side of the exhaust port.

### CROSS REFERENCE TO RELATED APPLICATION

The present application claims priority to Korean Patent Application No. 10-2017-0115972, filed Sep. 11, 2017, the entire contents of which is incorporated herein for all purposes by this reference.

### BACKGROUND

### Field of the Invention

The present invention relates to a gasoline direct injection engine, and more particularly, to a gasoline direct injection engine configured to directly inject fuel by an injector disposed at a side of an exhaust port.

### Description of the Related Art

In general, a gasoline direct injection (GDI) technology has been developed to improve fuel efficiency and performance of an internal combustion engine. The GDI engine technology directly injects fuel into the combustion chamber rather than into the intake pipe.

Since it is possible to directly inject fuel into the combustion chamber and produce an air-fuel mixture layer using the GDI engine, it is possible to produce a condensed mixture by concentrating air and fuel around a spark plug. Accordingly, the engine is capable of operating at a minimal air-fuel ratio and wall wetting is reduced in comparison to injecting fuel to the intake port in the related art, such that it is possible to accurately control the amount of fuel and improve fuel efficiency and performance, and accordingly, GDI engines are recently increasingly used

Various methods of mixing air with fuel well and maximally concentrating an air-fuel mixture around the spark plug has been proposed to smoothly operate the engine at a small air-fuel ratio. A vortex is generated with respect to the movement direction of the piston in the internal combustion engine, which is called ‘tumble’. Since the mixing ratio and concentration of the air and fuel depend on the flow level of the tumble, design should take into consideration to improve the operational performance of the GDI engine. Since the tumble particularly depends on the shape of the upper surface of the piston, the design of the top of the piston should be improved to improve the operational performance of the GDI engine.

Meanwhile, FIG. 1 is a diagram showing a conventional gasoline direct injection engine, and as shown in the drawing, the conventional gasoline direct injection engine includes an injector 40 disposed at a side of an intake port 10. In particular, the conventional gasoline direct injection engine includes: the intake port 10 configured to supply air to a combustion chamber, an exhaust port 20 configured to discharge exhaust gas generated in the combustion chamber to the outside; a spark plug 30; the injector configured to directly inject fuel into the combustion chamber, and a piston head 50. The injector 40 is installed at the side of the intake port 10 to cause the air introduced from the intake port 10 into the combustion chamber to be mixed with the fuel injected from the injector 40. However, there is a limit to improving the flow of the mixture in the structure of the injector 40 installed at the side of the intake port 10. Reference numeral 11 in FIG. 1 designates an intake pipe, 12 designates an intake valve, 21 designates an exhaust pipe, and 22 designates an exhaust valve.

The foregoing is intended merely to aid in the understanding of the background of the present invention, and is not intended to mean that the present invention falls within the purview of the related art that is already known to those skilled in the art.

### SUMMARY

Accordingly, the present invention provides a gasoline direct injection engine with an injector disposed at a side of an exhaust port, thereby improving flow characteristics and combustion performance of mixture.

According to one aspect of the present invention, a gasoline direct injection engine may include: an injector configured to directly inject fuel into a combustion chamber, a spark plug; an intake port; an exhaust port; and a piston head, wherein the intake port and the exhaust port are disposed to face each other based on an installation location of the spark plug, and the injector may be disposed at a side of the exhaust port.

An installation angle θ of the injector may be less than about 45°, wherein, the installation angle θ is an angle defined by a central imaginary line of the injector and an upper surface of the piston head. The intake port may include an intake pipe through which air supplied to the combustion chamber flows and an intake valve opening and closing the intake pipe, and an installation angle of the intake pipe is greater than the installation angle θ of the injector. An upper surface of the piston head may include a flow groove to return all or some of a flow of the fuel injected from the injector toward the exhaust port. The flow groove may be a circular or elliptical groove formed on the upper surface of the piston head, and the flow groove may be eccentrically formed from a center of the piston head toward the injector.

According to the exemplary embodiment of the present invention, since the injector directly injecting fuel into the combustion chamber may be disposed at a side of the exhaust port, it may be possible to improve performance of mixing air with fuel by increasing the tumble ratio in the combustion chamber. Further, since the injector may be disposed at a side of the exhaust port and the shape of the upper surface of the piston head is improved, it may be possible to prevent formation of a liquid film on the upper surface of the piston head.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a diagram showing a conventional gasoline direct injection engine according to the related art;

FIG. 2A is a diagram showing a gasoline direct injection engine according to an exemplary embodiment of the present invention;

FIG. 2B is a view showing a shape of an upper surface of a piston head according to an exemplary embodiment of the present invention;

FIGS. 3A and 3B are views showing flow of mixture in the conventional gasoline direct injection engine according to the related art;

FIGS. 4A and 4B are views showing flow of mixture in the gasoline direct injection engine according to an exemplary embodiment of the present invention; and

FIGS. 5A to 5D are graphs showing experimental results according to Comparative examples and Examples.

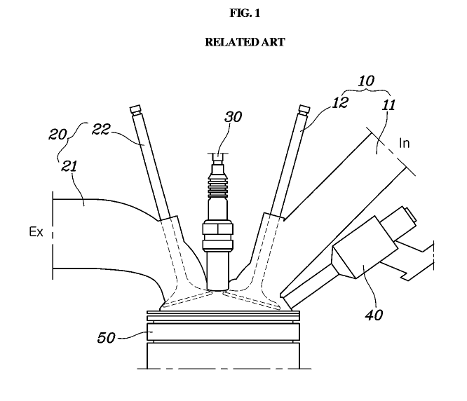

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinbelow, exemplary embodiments of the present invention will be described in detail with reference to the accompanying drawings. However, it should be understood that the embodiment of the present invention may be changed to a variety of exemplary embodiments and the scope and spirit of the present invention are not limited to the embodiment described hereinbelow. The exemplary embodiment of the present invention described hereinbelow is provided for allowing those skilled in the art to more clearly comprehend the present invention. Wherever possible, the same reference numerals will be used throughout the drawings and the description to refer to the same or like parts.

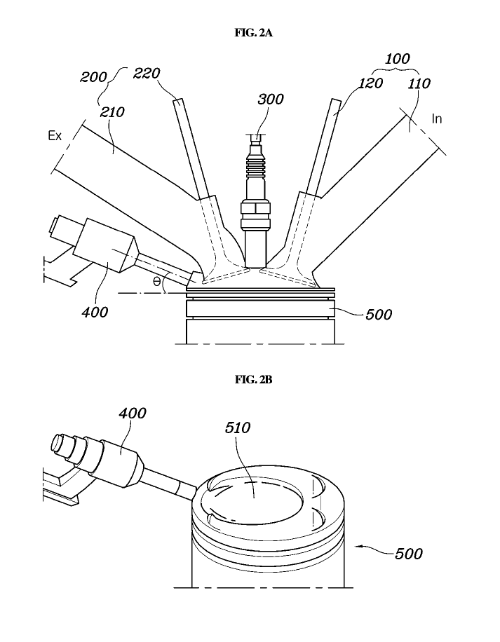

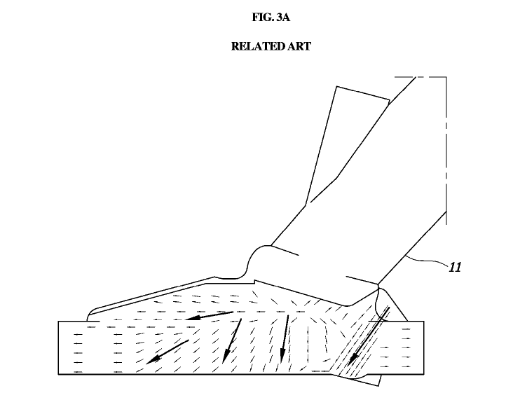

FIG. 2A is a diagram showing a gasoline direct injection engine according to an exemplary embodiment of the present invention; and FIG. 2B is a view showing a shape of an upper surface of a piston head according to an exemplary embodiment of the present invention. As shown in the drawings, the gasoline direct injection engine according to an exemplary embodiment of the present invention may include: an intake port 100; an exhaust port 200; a spark plug 300; an injector 400; and a piston head 500. In particular, the injector 400 may be disposed at a side of the exhaust port 100.

The intake port 100 may be configured to supply air to a combustion chamber, and may include an intake pipe 110 through which the air flows, and an intake valve 120 configured to adjust the flow of the air flowing in the intake pipe 110 based on an opening and closing thereof. The exhaust port 200 may be configured to discharge exhaust gas generated in the combustion chamber to the outside, and may include an exhaust pipe 210 through which the exhaust gas flows, and an exhaust valve 220 configured to adjust the flow of the exhaust gas discharged to the exhaust pipe 210 based on an opening and closing thereof.

The intake port 100, exhaust port 200, spark plug 300, and the injector 400 may be installed in the cylinder head, wherein the spark plug 300 may be disposed approximately at the central area of the combustion chamber, and the intake port 100 and the exhaust port 200 may be disposed to face each other based on the installation location of the spark plug 300. In particular, although two intake ports 100 and two exhaust ports 200 are installed in one combustion chamber, one of each is shown in the drawings.

Meanwhile, the key idea of the present invention is to install the injector 400 at the side of the exhaust port 200. In other words, the injector 400 may be installed at the side of the exhaust port 200, and specifically, installed between two exhaust ports 200. Thus, the injector 400 may be installed approximately at the central area between two exhaust ports 200 of the rim of the combustion chamber.

Particularly, an installation angle θ of the injector 400 may be less than 45°. Herein, the installation angle θ of the injector 400 is an angle defined by a central imaginary line of the injector 400 and an upper surface of the piston head 500. The installation angle θ of the injector 400 may be less than about 45° such that the flow of fuel injected from the injector 400 and the flow of fuel injected from the injector 400 and reflected while colliding with the upper surface of the piston head 500 mix or collide with the flow of air supplied from the intake pipe 110 to increase the amount of tumble. When the installation angle θ of the injector 400 is greater than 45°, the flow of fuel injected into the combustion chamber is reflected on the upper surface of the piston head 500 and then flows toward the cylinder head again, whereby the amount of tumble generated when the flow of the fuel collides with the flow of air supplied from the intake pipe 110 is less than that of the case where the installation angle θ is less than 45°.

Further, an installation angle of the intake pipe 110 may be greater than the installation angle θ of the injector 400. The intake pipe 110 and the injector 400 may be installed at opposite positions and the injector 400 may be installed at a smaller installation angle than the intake pipe 110 to thus sufficiently mix the air supplied through the intake pipe 110 and the fuel injected from the injector 400. For example, fuel may be supplied from the injector 400 at the start of the intake flow as the intake valve 120 is opened, and flows in the same rotational direction to generate a rotational flow of the mixture in the combustion chamber.

Meanwhile, to improve performance of mixing air with fuel in the combustion chamber, the shape of the upper surface of the piston head 500 is improved. As shown in FIG. 2B, the upper surface of the piston head 500 may be formed with a flow groove 510 to return all or some of flow of the fuel injected from the injector 400 toward the exhaust port 200. In particular, the flow groove 510 may be a circular or elliptical concave groove formed on the upper surface of the piston head 500, and may be eccentrically formed from a center of the piston head 500 toward the injector 400. Accordingly, the flow groove induces a tumble-like flow to the fuel injected from the injector 400. In other words, the flow groove 510 may be formed overall in a curved shape in a state of being biased toward the exhaust port 200 such that the fuel flowing from the intake port 100 toward the exhaust port 200 gradually moves upward.

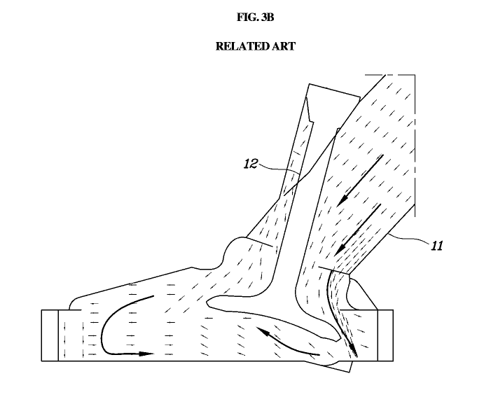

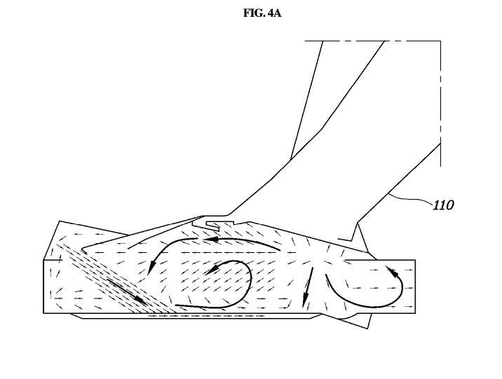

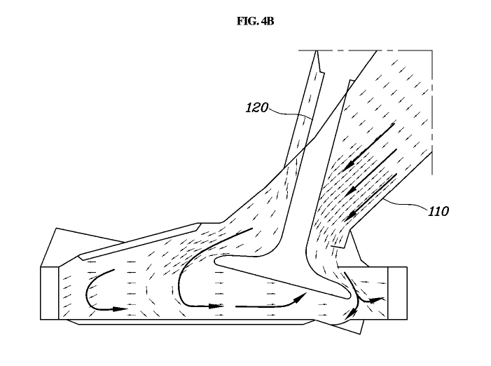

The present invention will be described by comparing the phenomenon of the flow of the mixture in the gasoline direct injection engine according to the present invention configured as described above and the conventional gasoline direct injection engine. FIGS. 3A and 3B are views showing flow of mixture in the conventional gasoline direct injection engine according to the related art; and FIGS. 4A and 4B are views showing flow of mixture in the gasoline direct injection engine according to an exemplary embodiment of the present invention.

In particular, FIG. 3A is a view showing the flow of the mixture at the start of the intake flow when the fuel is injected from an injector 40 while an intake valve 12 closes an intake pipe 11 in the conventional gasoline direct injection engine; and FIG. 3B is a view showing the flow of the mixture in the state where the intake valve 12 opens the intake pipe 11 in the conventional gasoline direct injection engine. Further, FIG. 4A is a view showing the flow of mixture at the start of the intake flow when the fuel is injected from the injector 400 in the state where the intake valve 120 closes the intake pipe 110 in the gasoline direct injection engine according to an exemplary embodiment of the present invention; and FIG. 4B is a view showing the flow of the mixture in the state where the intake valve 120 opens the intake pipe 110 in the gasoline direct injection engine according to the exemplary embodiment of the present invention.

Comparing FIGS. 3A and 4A, when the fuel is injected from the exhaust port 200 side as in the present invention, the tumble in the combustion chamber is generated by providing injection momentum in the same rotational direction at the start of the intake flow after the inlet valve opening (IVO). However, when the fuel is injected from the intake port 10 side in the conventional art, no tumble occurs in the combustion chamber.

Further, comparing FIGS. 3B and 4B, when the fuel is injected from the exhaust port 200 side as in the present invention and when the fuel is injected from the intake port 10 side as in the conventional art, the flow of the mixture is similar in both cases. However, the flow of the mixture when the fuel is injected from the exhaust port 200 side as in the present invention is more active than when the fuel is injected from the intake port 10 side as in the conventional art.

Moreover, the present invention will be described by comparing Comparative examples and Examples. Experiments were conducted to investigate the effective mixing performance of injection fuel under high speed, full load conditions. The operating conditions were 5500 rpm/WOT and 6750 rpm/WOT single injection condition, and as the injector, Y14 230-91 (OVAL type; rated flow: 1107.8 g/min@100 bar) was used.

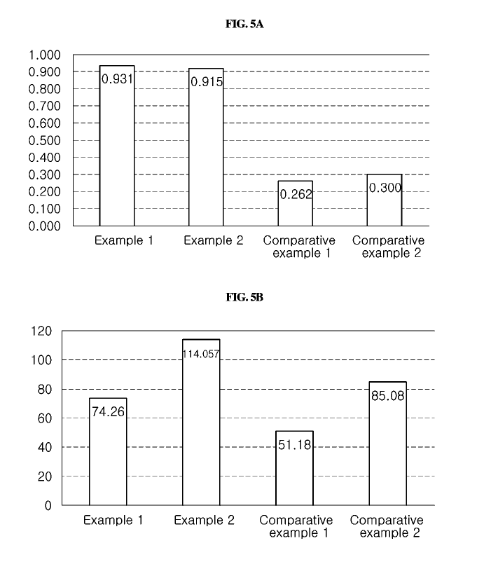

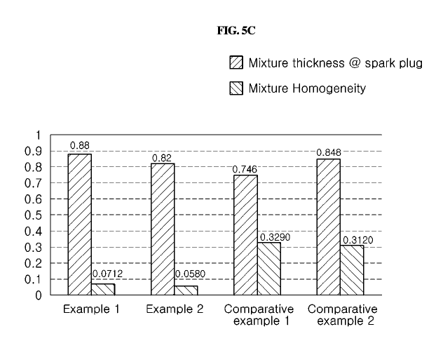

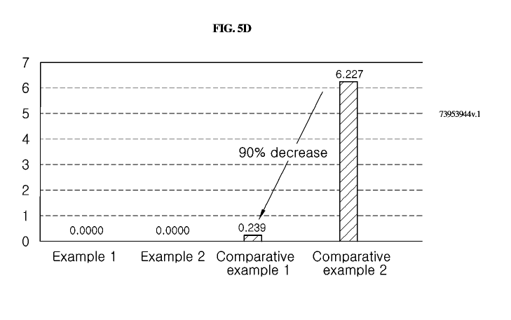

Example 1 is operation of the gasoline direct injection engine having an exhaust port side fuel injection structure according to the present invention at 5500 rpm/WOT, and Example 2 is operation of the gasoline direct injection engine having the exhaust port side fuel injection structure according to the present invention at 6750 rpm/WOT. Additionally, Comparative example 1 is operation of the conventional gasoline direct injection engine having an intake port side fuel injection structure at 5500 rpm/WOT, and Comparative example 2 is operation of the conventional gasoline direct injection engine having the intake port side fuel injection structure at 6750 rpm/WOT. The tumble ratio, turbulent kinetic energy, mixture characteristics, and liquid film mass ratio were measured under operating conditions according to the Examples and Comparative examples, and the results are shown in FIGS. 5A to 5D.

FIGS. 5A to 5D are graphs showing experimental results according to Comparative examples and Examples. FIG. 5A is a result of measuring the tumble ratio at inlet valve closing (IVC) of Examples and Comparative examples, and as shown in FIG. 5A, in Examples 1 and 2, the tumble ratio (based on IVC) is increased by about 3.55 times as compared with the tumble ratio of Comparative Examples 1 and 2. As a result, the graphs show that the performance of mixing air with fuel is improved in the Examples in comparison with the Comparative examples. In particular, the initial injection momentum of the fuel at the exhaust port side coincides with the flow direction of rotation, which increases the tumble.

FIG. 5B shows the result of measuring the turbulent kinetic energy at the top dead center (TDC), and as shown in FIG. 5B, in Examples 1 and 2, the turbulent kinetic energy at the TDC is increased by about 1.4 times as compared with the turbulent kinetic energy of Comparative Examples 1 and 2. As a result, there is a possibility that the combustion rate increases in the Examples in comparison with the Comparative examples.

FIG. 5C shows the result of measuring the mixture characteristics, wherein Mixture thickness shown in FIG. 5C indicates the mixture thickness around the spark plug, and Mixture Homogeneity indicates the degree of mixture of fuel and air. When the value indicated by Mixture Homogeneity is lower, the mixture may be determined to have been mixed uniformly. As shown in FIG. 5C, the mixture thickness around the spark plug is 0.85 in the Examples and 0.80 in the Comparative examples, and it is found that the Examples tend to be somewhat thinner than the Comparative examples. However, in Examples, the mixture homogeneity in the combustion chamber as a whole is improved by about 80% compared with the Comparative examples, and it is confirmed that the exhaust side injection is advantageous for a homogeneous mixture formation.

FIG. 5D shows the result of measurement of the liquid film mass ratio at the piston head, and as shown in FIG. 5D, in Examples, minimal liquid film is formed, and in Comparative examples, a substantial liquid film is formed due to the fact that the fuel is scattered before reaching the upper surface of the piston head and mixed with the air to form the mixture by disturbance of the injection pattern of the fuel due to the intake momentum. However, as provided in Comparative example 2, a substantial liquid film is formed. In Comparative example 1 rather than in Comparative example 2, the liquid film formation is substantially decreased, but the formation of liquid film is not completely suppressed as in Examples.

Although an exemplary embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A gasoline direct injection engine, comprising:
an injector configured to directly inject fuel into a combustion chamber,
a spark plug;
an intake port configured to supply air to the combustion chamber,
an exhaust port configured to discharge exhaust gas generated in the combustion chamber to an outside, wherein the injector is disposed at a side of the exhaust port; and
a piston head,
wherein the intake port and the exhaust port are disposed to face each other based on an installation location of the spark plug.

2. The gasoline direct injection engine of claim 1, wherein an installation angle of the injector is less than about 45° and the installation angle is an angle defined by a central imaginary line of the injector and an upper surface of the piston head

3. The gasoline direct injection engine of claim 2, wherein the intake port includes an intake pipe through which air supplied to the combustion chamber flows and an intake valve configured to open and close the intake pipe, and an installation angle of the intake pipe is greater than the installation angle of the injector.

4. The gasoline direct injection engine of claim 1, wherein an upper surface of the piston head includes a flow groove to return all or some of a flow of the fuel injected from the injector toward the exhaust port.

5. The gasoline direct injection engine of claim 4, wherein the flow groove is a circular or elliptical groove formed on the upper surface of the piston head, and the flow groove is eccentrically formed from a center of the piston head toward the injector.

6. The gasoline direct injection engine of claim 5, wherein the flow groove induces a tumble-like flow to the fuel injected from the injector.
